(19) United States
(12) Patent Application Publication
(10) Pub. No.: US 2025/0199508 A1
(43) Pub. Date: Jun. 19, 2025

(54) ENERGY-SAVING MANAGEMENT SYSTEM, MANUFACTURING MACHINE INCLUDING THE SAME AND METHOD OF ENERGY-SAVING MANAGEMENT

(71) Applicant: AT Save Company Limited, Nantou City (TW)

(72) Inventor: Jia Wei LIOU, Nantou City (TW)

(21) Appl. No.: 18/429,987

(22) Filed: Feb. 1, 2024

(30) Foreign Application Priority Data
Dec. 15, 2023 (TW) 112148931

(51) Int. Cl. G05B 19/4155; H02J 13/00

(52) U.S. Cl. CPC G05B 19/4155; H02J 13/00028; G05B 2219/34306

(57) ABSTRACT

An energy-saving management system for a manufacturing machine, including an energy consumption measurement module, a product-sensing module, a control module, and a display unit is disclosed. The energy consumption measurement module is coupled to the control module for monitoring the energy usage of the manufacturing machine; the product-sensing module is coupled to the control module for detecting each product to be processed by the manufacturing machine, and calculating the quantity of the processed products; the control module receives data from the energy consumption measurement module and the product-sensing module, and generates energy consumption data and carbon emission data per unit product; the display unit is coupled to the control module to display the energy consumption data and carbon emission data per unit product.

### CROSS-REFERENCE TO RELATED APPLICATIONS

This application claims the benefit of priority to Taiwan Patent Application No. 112148931, filed on Dec. 15, 2023. The entire content of the above-identified application is incorporated herein by reference.

### BACKGROUND

### Technical Field

The present disclosure relates to an energy-saving management system, and more particularly related to an energy-saving management system for providing energy consumption per unit of product, a machine including the energy-saving management system, and a method for energy-saving management for a manufacturing machine.

### Description of Related Art

Since the impact of global warming on the environment and climate is becoming more and more serious, the implementation of energy-saving and carbon reduction has become a global trend. To achieve energy conservation and reduce carbon emissions, energy monitoring and management systems are installed on home appliances or factory manufacturing equipment to monitor and control the energy consumption thereof.

The conventional energy management system is a system that monitors and collects energy usage data and then analyzes the energy usage data to provide an optimized energy utilization method to achieve energy-saving. Such systems use various technologies and methods to track energy usage, determine the causes of energy waste, and provide optimization recommendations. Conventional energy management systems usually have meters and sensors for real-time monitoring of energy usage, such as electricity, gas, or water. These monitoring data are then collected and stored in a database for further analysis and evaluation.

However, the information presented by the conventional energy management system usually shows the energy consumption data of the machine on an hourly basis. For example, the current hourly power usage of the machine is 1 kilowatt (kW), or the power usage of the machine in the past hour is 1.2 kW, etc. Although monitoring and analyzing the machine's energy consumption on an hourly basis, and then making appropriate control of the machine can achieve the purpose of saving energy consumption. However, the operators of the manufacturing machines in the factory production line often lack a sense of the energy consumption information on the screen of the machine, which simply displays hourly energy consumption information. Therefore, the energy consumption information provided by the energy management system can hardly make the operators of the manufacturing machines willing to take the initiative to cooperate in energy-saving and carbon reduction.

### BRIEF SUMMARY OF THE INVENTION

Therefore, an object of the present invention is to provide an energy-saving management system for real-time monitoring of energy consumption per unit of product of a manufacturing machine to improve the efficiency of energy-saving and carbon reduction. The energy-saving management system includes an energy consumption measurement module, a product-sensing module, a control module, and a display unit, wherein the energy consumption measurement module is adapted to measure energy usage of the manufacturing machine; the product-sensing module is adapted to monitor each product processed by the manufacturing machine and calculate quantity of the products being processed; the control module is coupled to the energy consumption measurement module and the product-sensing module, and adapted to generate energy consumption data per unit of product and carbon emission data per unit of product; the display unit is coupled to the control module, and adapted to display energy consumption data per unit of product, and/or carbon emission data per unit of product.

According to an embodiment of the present invention, the control module of the energy-saving management system includes a machine energy consumption calculation module, an unit product energy consumption analysis module, an unit product carbon emission analysis module, and an alert module; wherein the machine energy consumption calculation module is adapted to receives the energy usage of the energy consumption measurement module, and generate energy consumption data of the manufacturing machine at different points in time; the unit product energy consumption analysis module is adapted to receive the energy consumption data from the machine energy consumption calculation module, and the quantity of the products being processed to generate energy consumption data per unit of product; the unit product carbon emission analysis module is adapted to converting the energy consumption data per unit of product into carbon emission data per unit of product; the alert module is adapted to determine whether the energy consumption data per unit of product and/or the carbon emission data per unit of product exceed a preset value.

According to an embodiment of the present invention, the energy-saving management system further includes a storage module coupled to the control module, for storing the energy usage measured by the energy consumption measurement module, the quantity of the products calculated from the product-sensing module, the energy consumption data per unit of product and carbon emission data per unit of product from the control module, the preset value and a carbon emission factor table.

According to an embodiment of the present invention, the energy-saving management system further includes an input unit coupled to the control module and adapted to input the preset value and the carbon emission factor table.

According to an embodiment of the present invention, the control module further includes an energy-saving circuit module coupled to the alert module; when the alert module determines that the energy consumption data per unit of product and/or the carbon emission data per unit of product exceed the preset value, the alert module transmits a control signal to the energy-saving circuit module to activate an energy-saving mode of the manufacturing machine.

According to an embodiment of the present invention, wherein the alert module transmits an alert signal to the display unit to show an alert message when the alert module determines that the energy consumption data per unit of product and/or the carbon emission data per unit of product exceeds the preset value.

According to an embodiment of the present invention, the energy-saving management system further includes a network communication module coupled to the control module, for connecting the manufacturing machine to a cloud server.

According to an embodiment of the present invention, wherein the display unit further includes an indicator light that changes color to indicate energy consumption; the alert module transmits a signal to activate the indicator light when the alert module determines that the energy consumption data per unit of product and/or the carbon emission data per unit of product exceeds the preset value.

According to an embodiment of the present invention, wherein the product-sensing module can further identify bar codes on the products being processed.

Another object of the present invention is to provide a manufacturing machine including the aforementioned energy-saving management system for real-time monitoring of energy consumption per unit of product to improve the efficiency of energy-saving and carbon reduction.

A further object of the present invention is to provide a method of energy-saving management for a manufacturing machine, including steps of measuring energy usage of the manufacturing machine; detecting a quantity of products being processed by the manufacturing machine per unit of time; calculating energy consumption data per unit of time; generating energy consumption per unit of product and carbon emission per unit of product according to the energy consumption data and the quantity of products processed per unit of time; and displaying the energy consumption per unit of product and the carbon emission per unit of product.

According to an embodiment of the present invention, wherein the method further includes determining whether the energy consumption per unit of product and/or the carbon emission per unit of product exceed a preset value; and displaying an alert message when the energy consumption per unit of product and/or the carbon emission per unit of product exceed the preset value.

According to an embodiment of the present invention, wherein the method further includes utilizing a caron emission factor to calculate the carbon emission per unit of product.

According to an embodiment of the present invention, wherein the method further includes a step of activating an energy-saving mode of the manufacturing machine when the energy consumption per unit of product and/or the carbon emission per unit of product exceeds the preset value.

According to an embodiment of the present invention, wherein the method further includes a step of sending the energy consumption per unit of product and the carbon emission per unit of product to a cloud server.

According to an embodiment of the present invention, wherein the method further includes a step of activating an indicator light when the energy consumption data per unit of product and/or the carbon emission data per unit of product exceed the preset value.

According to an embodiment of the present invention, wherein the method further includes a step of identifying bar codes on products when calculating the quantity of the products being processed.

### BRIEF DESCRIPTION OF THE DRAWINGS

FIG. 1 is a schematic diagram of the energy-saving management system according to the first embodiment of the present invention;

FIG. 2 shows the power curve of a manufacturing machine at different points in time;

FIG. 3A is a schematic diagram of the power curve and product output variations of the manufacturing machine over a period of time including an idle state;

FIG. 3B is a schematic diagram of the power curve and product output variations of the manufacturing machine during a normal operation state;

FIG. 4 is a schematic diagram of a screen image of the display unit of the energy-saving management system according to the present invention;

FIG. 5 is a flow chart of the operation method of the energy-saving management system of the first embodiment of the present invention; and

FIG. 6 is a schematic diagram of the energy-saving management system according to the second embodiment of the present invention.

### DETAILED DESCRIPTION OF THE INVENTION

The invention will now be described more fully hereinafter with reference to the accompanying drawings, in which example embodiments of the present invention are shown. The invention may, however, be embodied in different forms and should not be construed as limited to the embodiments set forth herein. Rather, these embodiments are provided to make the technical features, contents, and advantages of the present invention more accessible to the persons skilled in the art.

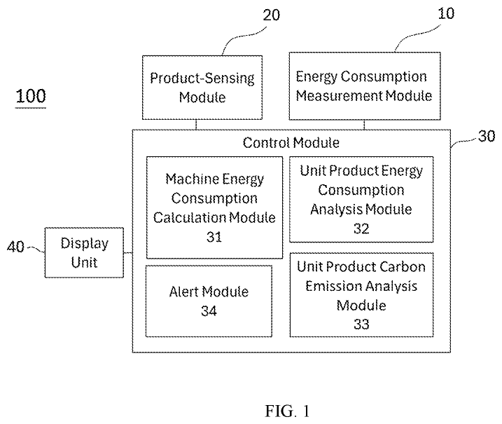

The energy-saving management system according to the present invention is suitable for installation on a manufacturing machine to provide real-time energy consumption and real-time carbon-emission information based on the number of the products processed by the manufacturing machine. In this way, the operators of the manufacturing machine could have a higher awareness and personal feeling of changes in energy consumption, thus guiding the operators to proactively adjust production capacity allocation and flexibly adjust machine energy supply, and effectively reduce the average energy consumption and carbon emissions of the manufacturing machine. Refer to FIG. 1, which is a schematic diagram of the energy-saving management system according to the first embodiment of the present invention. The energy-saving management system 100 of the first embodiment includes an energy consumption measurement module 10, a product-sensing module 20, a control module 30, and a display unit 40. The energy consumption measurement module 10 and the product-sensing module 20 are respectively coupled to the control module 30, and respectively transmit the energy consumption data and the number of products processed by the manufacturing machine to the control module 30. The control module 30 analyzes the energy consumption data and the number of processed products to generate energy consumption data and carbon emission data per unit of product and transmits the energy consumption data and carbon emission data per unit of product to the display unit 40. The monitor 40 visually displays the energy consumption and carbon emission data of each product processed by the manufacturing machine, thereby providing real-time monitoring of the energy consumption data of each of the processed products.

The energy consumption measurement module 10 is composed of an energy supply sensor installed on the manufacturing machine to collect the energy consumption of the manufacturing machine. For example, the energy consumption measurement module 10 can measure the electricity usage or gas usage of the manufacturing machine. In the present embodiment, the energy consumption measurement module 10 is a power sensor for measuring the current variation of the manufacturing machine and generating power consumption data of the manufacturing machine. The energy consumption measurement module 10 can measure the current used by the manufacturing machine over a period of time, thus obtaining the power consumption at a number of different points in time to generate energy consumption history data of the manufacturing machine corresponding to the different points in time. The energy consumption measurement module 10 can continuously measure the energy usage of the manufacturing machine in different time periods, including a standby mode, an energy-saving mode, a maintenance mode, and a normal operation mode of the manufacturing machine, and calculate the energy usage thereof. Then, the energy usage data is transmitted to the control module 30 to analyze the energy consumption of the manufacturing machine at different points in time. In one embodiment, the energy consumption measurement module 10 can include a current-sensing circuit unit. It should be noted that, for convenience of explanation, the power consumption measurement data used in the following description is denoted with power unit.

The product-sensing module 20 is composed of a sensor installed on the manufacturing machine and can monitor the quantity of products processed by the manufacturing machine. The product-sensing module 20 can detect each product transported to the manufacturing machine for processing to count the number of processed products at different points in time. For example, the product-sensing module 20 is a product counter with a timer function that can count the number of products processed by the manufacturing machine within a period of time and generate time-distributed production data. Taking a shoe processing machine as an example, the product-sensing module 20 can count the number of sports shoes processed by the manufacturing machine per hour at different time points to generate production history data. Furthermore, each product can be attached with a bar code, so that the product sensing module 20 can identify each product that enters the manufacturing machine. When the production statistics are carried out, the processing machine and the processing time when each product is processed can also be recorded at the same time. The processing data of each product can be transmitted to the control module 30, to facilitate the subsequent tracking and processing.

The control module 30 is coupled to the energy consumption measurement module 10 and the product-sensing module 20 to generate energy consumption data per unit of product and carbon emission data per unit of product. The control module 30 is composed of hardware (e.g., a chipset) with computing capability. As shown in FIG. 1, the control module 30 includes a machine energy consumption calculation module 31, a unit product energy consumption analysis module 32, a unit product carbon emission analysis module 33, and an alert module 34.

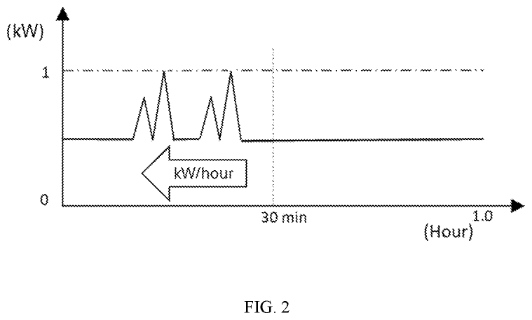

The machine energy consumption calculation module 31 is used to calculate a plurality of energy consumption data corresponding to the manufacturing machine based on the energy usage data of the manufacturing machine provided by the energy consumption measurement module 10. For example, when the manufacturing machine is a shoe processing machine, the variation of the power curve of the shoe processing machine at different points in time is shown in FIG. 2. The peak zone of the power curve in FIG. 2 is the normal operation mode of the shoe processing machine for processing the product, while the horizontal zone of the power curve in FIG. 2 is the standby mode of the shoe processing machine. As shown in FIG. 2, the energy consumption of the shoe processing machine is 1 kilowatt per hour (1 kW/hour) within an hour.

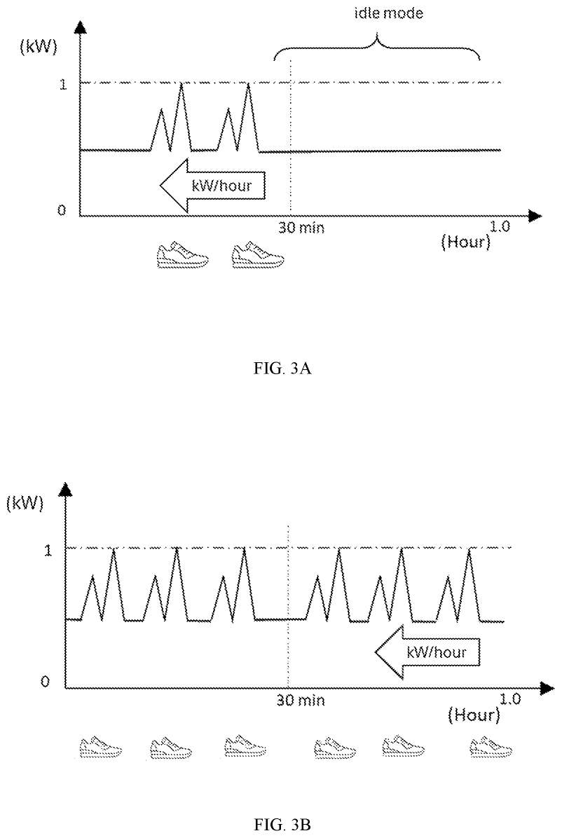

The unit product energy consumption analysis module 32 is used to receive the number of products detected by the product-sensing module 20 and the energy consumption data provided by the machine energy consumption calculation module 31 and to generate the energy consumption data per unit of product by analyzing the energy consumption data of the processed products at different points in time. As shown in FIG. 3A, two pairs of sports shoes were processed in the current 30 minutes, but the manufacturing machine was idle in the previous 30 minutes. Since there is still a standby mode (idle mode) power usage, the overall power consumption of the manufacturing machine in one hour is 1 kilowatt (1 kW). Therefore, the energy consumption data based on the unit product is calculated to be 500 W/pair. Also referring to FIG. 3B, the energy usage data of the manufacturing machine for another period of time was shown. As shown in the figure, the manufacturing machine was in normal operation for one hour and processed a total of six pairs of sports shoes. The overall power consumption of the shoe processing machine of 1.5 kilowatts (1.5 kW) in one hour, so that the energy consumption data based on the unit product is calculated to be 250 W/pair.

The unit product carbon emission analysis module 33 can retrieve a carbon emission factor table from a storage unit of the control module 30, and calculate the carbon emission (carbon dioxide emission) of each product based on the energy consumption data per unit of product provided by the unit product energy consumption analysis module 32. For example, as shown in FIG. 2, assuming that the power consumption of each pair of shoes is 0.5 kW/pair, the energy consumption is equivalent to 0.5 kWh/pair; when the carbon emission factor is 0.493 kgCO₂ per kWh, the carbon emission of each pair of shoes is 0.247 kgCO₂/pair. Hence, the unit product carbon emission analysis module 33 can generate carbon emission data based on per unit of product.

The alert module 34 compares the energy consumption data (energy consumption data per unit of product, and/or carbon emission data per unit of product) with a preset value to determine whether the energy consumption data is higher than the preset value or not, and transmits the result to the display unit 40. The preset value includes an energy usage reference value that is preset and stored in the control module 30. For example, the preset value of the energy consumption per unit of product can be 300 W/pair. Referring to FIG. 3A, when the energy consumption per pair of sports shoes is 500 W/pair, the alert module 34 determines that the current energy consumption per unit of product exceeds the preset value of energy consumption per unit of product (300 W/pair), and sends an alert signal to the display unit 40. Referring to FIG. 3B, when the energy consumption per pair of sports shoes is 250 W/pair, the alert module 34 determines that the current energy consumption per unit of product is within a limit of the preset value of energy consumption per unit of product and does not generate the alert signal.

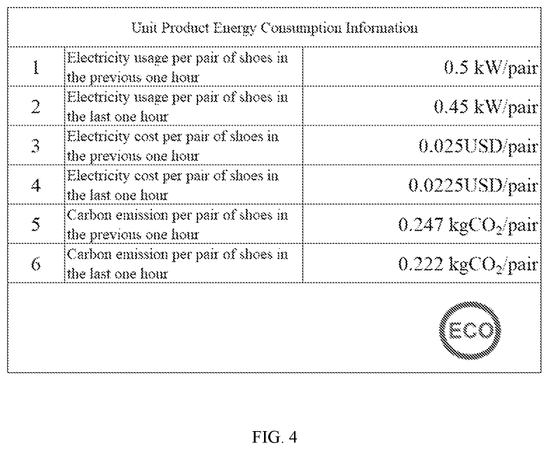

The display unit 40 is coupled to the control module 30 and is used to receive and display the energy consumption data per unit of product from the control module 30 and a signal (such as an indicator light of energy consumption) showing whether the energy consumption per unit of product exceeds the preset value or not. For example, the display unit 40 can be a monitor including a screen showing the energy consumption per unit of product. FIG. 4 is a schematic diagram of a screen image of the display unit 40 of the energy-saving management system 100 according to the present invention. In FIG. 4, a shoe-processing machine is used as an example of the manufacturing machine, and the unit production is in the unit of one pair of shoes. The data of the energy consumption per unit of product can be shown on the display unit 40 according to the calculation result of the unit product energy consumption analysis module 32, the unit product carbon emission analysis module 33, and the alert module 34. As shown in FIG. 4, both the electricity usage and the cost of electricity per pair of shoes in the last hour, and the carbon dioxide emission of each pair of shoes are shown on the screen of the display unit 40. At the same time, in order to provide information about changes in the amount of energy consumed, the amount of electricity consumed and the cost of electricity consumed for each pair of shoes in the previous hour, as well as the amount of carbon dioxide emission for each pair of shoes can also be shown on the screen of the display unit 40. Further, the screen of the display unit 40 can include an indicator light (e.g., an ECO light) that changes color to indicate energy consumption. For example, when the power consumption per pair of shoes for the hour is within the limit of the preset value, an ECO green light is displayed on the screen; when the power consumption per pair of shoes for the hour exceeds the limit of the preset value, an ECO red light is displayed on the screen. By displaying real-time information on energy consumption per unit of product, the operator of the manufacturing machine can clearly feel the data on electricity usage and carbon dioxide emission of each pair of shoes produced, which in turn guides the operator to adjust the power supply mode of the manufacturing machine promptly, so as to reduce the energy consumption of the manufacturing machine.

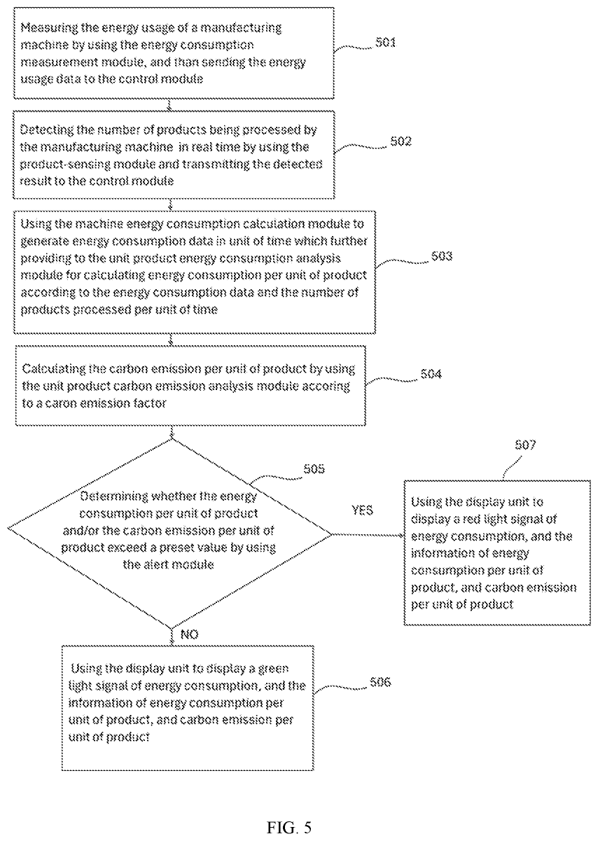

Referring to FIG. 5, a flow chart of an operation method of the energy-saving management system 100 according to the present invention is shown. First, in Step 501, the energy consumption measurement module 10 is utilized to measure the energy usage of a manufacturing machine, such as electricity usage, and then the energy usage data is sent to the control module 30. In Step 502, the product-sensing module 20 detects the number of products being processed by the manufacturing machine in real-time and transmits the detected result to the control module 30. In Step 503, the machine energy consumption calculation module 31 generates energy consumption data in unit of time and provides the energy consumption data to the unit product energy consumption analysis module 32; then, the unit product energy consumption analysis module 32 generates the energy consumption per unit of product according to the energy consumption data and the number of products processed per unit of time. In Step 504, the unit product carbon emission analysis module 33 calculates and outputs the carbon emission per unit of product according to a carbon emission factor. In Step 505, the alert module 34 determines whether the energy consumption per unit of product and/or the carbon emission per unit of product exceed a preset value. If yes, in Step 506, a message is transmitted to the display unit 40, and the display unit 40 displays a red light signal of energy consumption and the information of energy consumption per unit of product, and carbon emission per unit of product; if not, in Step 507, a message is transmitted to the display unit 40, and the display unit 40 displays a green light signal of energy consumption, and the information of energy consumption per unit of product and carbon emission per unit of product.

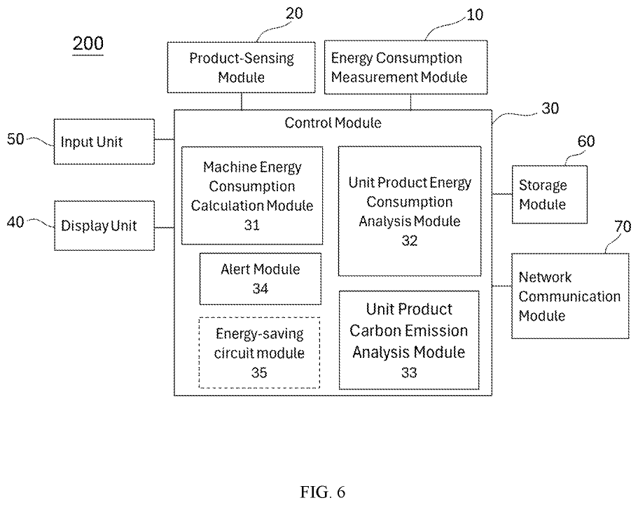

Referring to FIG. 6, a schematic diagram of the energy-saving management system according to the second embodiment of the present invention is shown. The energy-saving management system 200 of the second embodiment mainly includes the same elements as the energy-saving management system 100 of the first embodiment. The energy-saving management system 200 of the second embodiment further includes an input unit 50 coupled to the control module 30 for the operator of the manufacturing machine to input the information required by the manufacturing machine, such as a preset value, a carbon emission factor, date and time, etc. The inputted information can be stored in the storage unit built in the control module 30.

The energy-saving management system 200 of the second embodiment can further include a storage module 60 coupled to a control module 30 for storing data generated by the energy consumption measurement module 10, the product-sensing module 20, and the control module 30, as well as externally inputted information, such as the preset value, the carbon emission factor, date and time, etc.

The energy-saving management system 200 of the second embodiment can further include a network communication module 70 coupled to the control module 30 to connect the manufacturing machine to the web, so that the manufacturing machine can be connected to a cloud server, and the energy consumption data of the manufacturing machine obtained by the energy-saving management system 100 can be transmitted to a central control system on the cloud server. Then, the energy consumption data can be further centralized managed, analyzed, and used.

In one embodiment, the control module 30 of the energy-saving management system 200 according to the present invention further includes an energy-saving circuit module 35. The energy-saving circuit module 35 is coupled to an alert module 34. When the alert module 34 determines that the energy consumption data per unit of product and the carbon emission data per unit of product exceeds the preset value, the alert module 34 can transmit a control signal to the energy-saving circuit module 35 to activate an energy-saving mode of the manufacturing machine promptly, in order to reduce the amount of energy usage of the manufacturing machine.

In summary, the energy-saving management system is applied to a manufacturing machine to present real-time energy consumption information on a product-by-product basis, thereby enabling the operator of the manufacturing machine to understand the actual energy consumption data of each product and to guide the operator to adjust the energy supply mode of the manufacturing machine promptly, which can effectively conserve energy, and reduce the amount of energy consumed by a product as well as the amount of carbon dioxide emissions.

The present invention has been described in terms of particular embodiments found or proposed by the inventor to comprise preferred methods for the practice of the present invention. It will be appreciated by those skilled in the art that, in light of the present disclosure, numerous modifications and changes can be made in the particular embodiments exemplified without departing from the intended scope of the invention. Moreover, due to biological functional equivalency considerations, changes can be made in methods, structures, and compounds without affecting the biological action in kind or amount. All such modifications are intended to be included within the scope of the appended claims.

What is claimed is:

1. An energy-saving management system for applying to a manufacturing machine, including:
an energy consumption measurement module used to measure energy usage of the manufacturing machine;
a product-sensing module adapted to monitor each product processed by the manufacturing machine and calculate quantity of the products being processed;
a control module coupled to the energy consumption measurement module and the product-sensing module, and adapted to generate energy consumption data per unit of product and carbon emission data per unit of product; and
a display unit coupled to the control module, and adapted to display energy consumption data per unit of product, and carbon emission data per unit of product.

2. The energy-saving management system according to claim 1, wherein the control module includes:
a machine energy consumption calculation module, for receiving the energy usage from the energy consumption measurement module, and generating energy consumption data of the manufacturing machine at different points in time;
a unit product energy consumption analysis module, for receiving the energy consumption data from the machine energy consumption calculation module, and the quantity of the products being processed to generate energy consumption data per unit of product;
an unit product carbon emission analysis module, for converting the energy consumption data per unit of product into carbon emission data per unit of product; and
an alert module, for determining whether the energy consumption data per unit of product and/or the carbon emission data per unit of product exceed a preset value.

3. The energy-saving management system according to claim 2, wherein the energy-saving management system further includes a storage module coupled to the control module, for storing the energy usage measured by the energy consumption measurement module, the quantity of the products calculated from the product-sensing module, the energy consumption data per unit of product and the carbon emission data per unit of product from the control module, the preset value and a carbon emission factor table.

4. The energy-saving management system according to claim 2, wherein the energy-saving management system further includes an input unit coupled to the control module and adapted to input the preset value and the carbon emission factor table.

5. The energy-saving management system according to claim 2, wherein the control module further includes an energy-saving circuit module coupled to the alert module; when the alert module determines that the energy consumption data per unit of product and/or the carbon emission data per unit of product exceed the preset value, the alert module transmits a control signal to the energy-saving circuit module to activate an energy-saving mode of the manufacturing machine.

6. The energy-saving management system according to claim 2, wherein the alert module transmits an alert signal to the display unit to show an alert message when the alert module determines that the energy consumption data per unit of product and/or the carbon emission data per unit of product exceed the preset value.

7. The energy-saving management system according to claim 2, wherein the energy-saving management system further includes a network communication module coupled to the control module, for connecting the manufacturing machine to a cloud server.

8. The energy-saving management system according to claim 2, wherein the display unit further includes an indicator light that changes color to indicate energy consumption; the alert module transmits a signal to activate the indicator light when the alert module determines that the energy consumption data per unit of product and/or the carbon emission data per unit of product exceed the preset value.

9. The energy-saving management system according to claim 1, wherein the product-sensing module can further identify bar codes on the products being processed.

10. A manufacturing machine, including the energy-saving management system of claim 1.

11. A method of energy-saving management for a manufacturing machine, including steps of:
measuring an energy usage of the manufacturing machine;
detecting quantity of products being processed by the manufacturing machine per unit of time;
calculating energy consumption data per unit of time;
generating energy consumption per unit of product and carbon emission per unit of product according to the energy consumption data and the quantity of products processed per unit of time; and
displaying the energy consumption per unit of product and the carbon emission per unit of product.

12. The method of claim 11, further comprising determining whether the energy consumption per unit of product and/or the carbon emission per unit of product exceed a preset value; and displaying an alert message when the energy consumption per unit of product and/or the carbon emission per unit of product exceed the preset value.

13. The method of claim 11, further comprising utilizing a caron emission factor to calculate the carbon emission per unit of product.

14. The method of claim 12, further comprising a step of activating an energy-saving mode of the manufacturing machine when the energy consumption per unit of product and/or the carbon emission per unit of product exceed the preset value.

15. The method of claim 11, further comprising a step of sending the energy consumption per unit of product and the carbon emission per unit of product to a cloud server.

16. The method of claim 12, further comprising a step of activating an indicator light when the energy consumption data per unit of product and/or the carbon emission data per unit of product exceed the preset value.

17. The method of claim 11, further comprising a step of identifying bar codes on products when calculating the quantity of the products being processed.
